(19) United States
(12) Patent Application Publication
(10) Pub. No.: US 2009/0323314 A1
(43) Pub. Date: Dec. 31, 2009

(54) Optical plate and backlight module using the same

(75) Inventor: Shao-Han Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Hon Hai Precision Industry Co., LTD

(21) Appl. No.: 12/319,007

(22) Filed: Dec. 31, 2008

(30) Foreign Application Priority Data
Jun. 30, 2008 (CN) 200810302432.2

(51) Int. Cl. F21V 5/02; F21V 5/00

(52) U.S. Cl. 362/97.2; 362/339

(57) ABSTRACT

An optical plate has a first surface and an opposite second surface. The first surface is substantially planar. A plurality of substantially parallel elongated V-shaped protrusions and a plurality of substantially parallel elongated arc-shaped protrusions are formed on the second surface of the transparent main body. Each elongated arc-shaped protrusion intersects with each elongated V-shaped protrusion. A backlight module using the optical plate is also provided.

This application is related to two co-pending U.S. patent applications, applications Ser. No. [to be determined], with Attorney Docket No. US21686 and US21604, and all entitled “OPTICAL PLATE AND BACKLIGHT MODULE USING THE SAME”. The inventor of the co-pending applications is Shao-Han Chang. The co-pending applications have the same assignee as the present application.

### BACKGROUND OF THE DISCLOSURE

1. Field of the Disclosure

The present invention relates to an optical plate and a backlight module using the same and, particularly, to an optical plate and a backlight module using the same employed in a liquid crystal display.

2. Description of the Related Art

Referring to FIGS. 9 and 10, a typical direct type backlight module 100 includes a frame 11, a plurality of light sources 12, a light diffusion plate 13, and a typical optical plate 10. The light sources 12 are positioned in an inner side of the frame 11. The light diffusion plate 13 and the typical optical plate 10 are positioned on the light sources 12 above a top of the frame 11. The light diffusion plate 13 includes a plurality of diffusing particles (not shown) to diffuse light. The typical optical plate 10 includes a transparent substrate 101 and a prism layer 103 formed on a surface of the transparent substrate 101. The prism layer 103 forms a plurality of elongated V-shaped protrusions 105.

Light from the light sources 12 enters the diffusion plate 13 and becomes scattered. The scattered light leaves the diffusion plate 13 to the prism sheet 10. The scattered light then travels through the typical optical plate 10 and is refracted out at the elongated V-shaped protrusions 105 of the typical optical plate 10. Thus, the refracted light leaving the typical optical plate 10 is concentrated at the prism layer 102 and increases the brightness (illumination) of the typical optical plate 10. The refracted light then propagates into a liquid crystal display panel (not shown) positioned above the typical optical plate 10.

However, light spot of the light sources 12 often occurs after light leaving the optical plate 10, even though light leaving the diffusion plate 13 becomes scattered. Referring to FIG. 11, if the diffusion plate 13 of the backlight module 100 is omitted, light emitted from the typical optical plate 10 will form two relatively strong light spots.

To reduce or eliminate the light spot of the light sources 12, the backlight module 100 may include an upper light diffusion film 14 positioned on the prism sheet 10. However, a plurality of air pockets exist at the boundary between the light diffusion film 14 and the prism sheet 10. When the liquid crystal display device 100 is in use, light passes through the air pockets, and some of the light undergoes total reflection at one or more boundaries. In addition, the upper light diffusion film 14 may absorb some of the light from the prism sheet 10. As a result, the light illumination brightness of the liquid crystal display device 100 is reduced.

Therefore, a new optical plate is desired in order to overcome the above-described shortcomings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of a first embodiment of an optical plate.

FIG. 2 is similar to FIG. 1, but viewed from another aspect.

FIG. 3 is cross-sectional view taken along the line II-II of FIG. 1.

FIG. 4 is a cross-sectional view taken along the line III-III of FIG. 1.

FIG. 5 is a photo showing an illumination distribution test result of an LED.

FIG. 6 is a photo showing an illumination distribution test result of the optical plate of FIG. 1 positioned above the LED.

FIG. 7 is a cross-sectional view of a second embodiment of an optical plate.

FIG. 8 is a cross-sectional view of the first embodiment of the optical plate in a backlight module.

FIG. 9 is a side cross-sectional view of a typical backlight module.

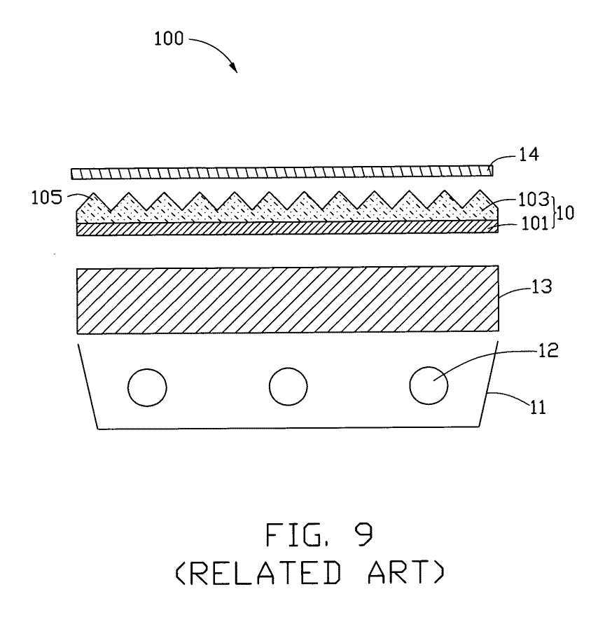

FIG. 10 is an isometric view of a typical optical plate in the typical backlight module of FIG. 10.

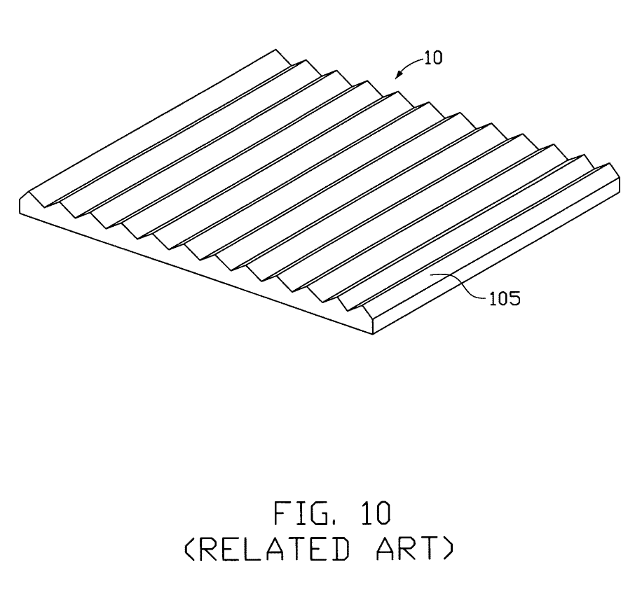

FIG. 11 is a photo showing an illumination distribution test result of the typical optical plate of FIG. 10 positioned above an LED.

### DETAILED DESCRIPTION OF THE PREFERRED EMBODIMENTS

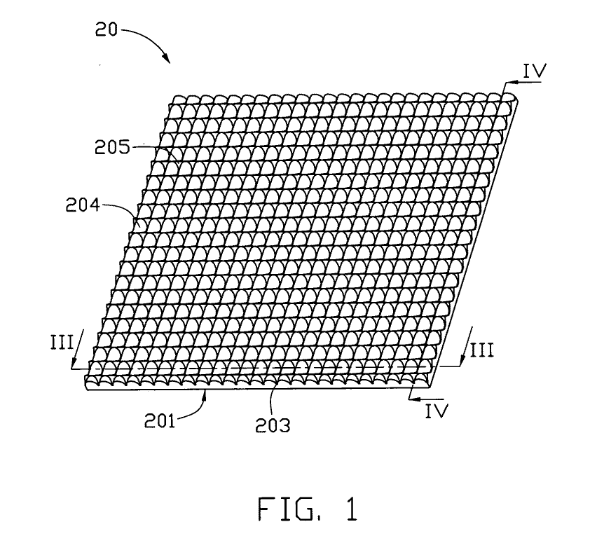

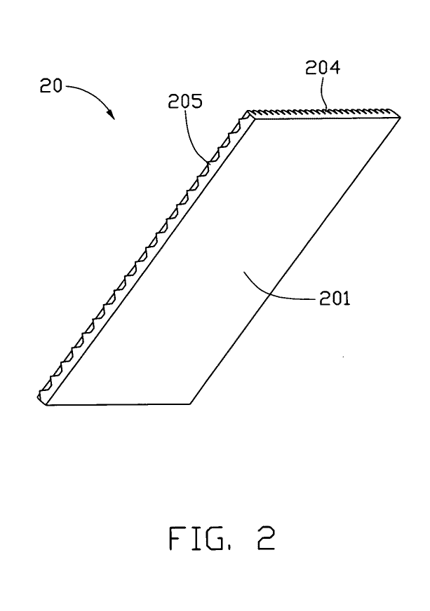

Referring to FIGS. 1 and 2, a first embodiment of an optical plate 20 includes a first surface 201 and a second surface 203 opposite the first surface 201. The first surface 201 is substantially planar. A plurality of elongated arc-shaped protrusions 204 and a plurality of elongated V-shaped protrusions 205 are formed on the first surface 201. The elongated arc-shaped protrusions 204 are substantially parallel to each other, and the elongated V-shaped protrusions 205 are substantially parallel to each other. The elongated arc-shaped protrusions 204 intersect with the elongated V-shaped protrusions 205. In the illustrated embodiment, each elongated arc-shaped protrusion 204 substantially perpendicularly intersects with each elongated V-shaped protrusion 205. A cross-section of each elongated arc-shaped protrusion 204 taken along a plane perpendicular to an extending direction of the elongated arc-shaped protrusion 204 may be substantially semicircular.

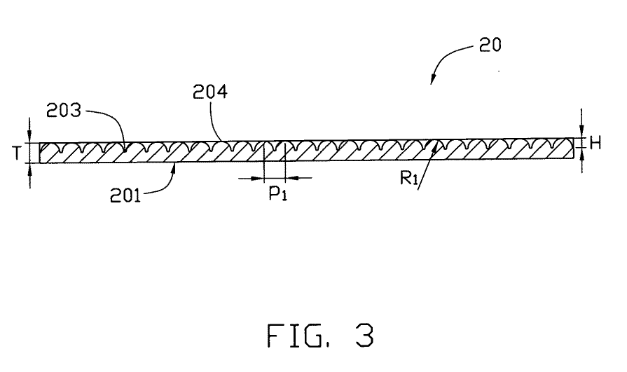

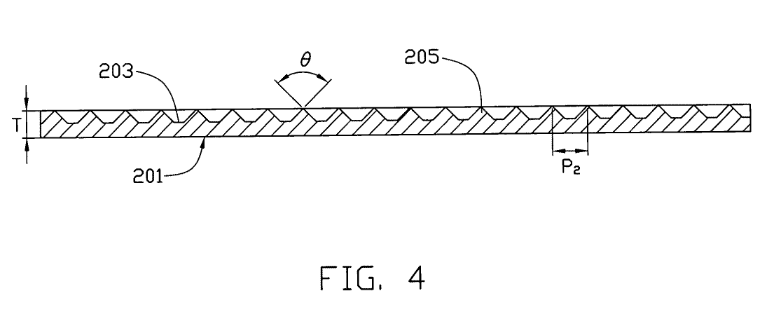

Referring to FIGS. 3 and 4, a pitch P₁ of adjacent elongated arc-shaped protrusions 204, measured between two corresponding points on the cross-section lines, is about 0.025 millimeters (mm) to about 1.5 mm. A radius R₁ of each elongated arc-shaped protrusion 204 is about 0.006 mm to about 3 mm. A pitch P₂ of adjacent elongated V-shaped protrusions 205, measured between two corresponding points on the cross-section lines, is about 0.025 mm to about 1.5 mm. A vertex angle θ of each elongated V-shaped protrusion 205 is about 80 degrees to about 100 degrees. A height H of each elongated arc-shaped protrusion 204 or elongated V-shaped protrusion 205 is about 0.01 mm to about 3 mm.

A thickness of the optical plate 20 is about 0.5 mm to about 3 mm. The optical plate 20 may be made of a material such as polycarbonate, polymethyl methacrylate, polystyrene, and copolymer of methyl methacrylate and styrene.

The optical plate 20 may be integrally formed by injection molding. That is, the elongated V-shaped protrusions 205, the elongated arc-shaped protrusions 204, and the main body 21 may be integrally formed by an injection molding method. Thus, the optical plate 20 has a better rigidity and mechanical strength than the typical optical plate 10. Therefore, the optical plate 20 has a relatively high reliability.

Referring to the Table 1 below, test samples show an optical performance of the optical plate 20 in contrast to that of the typical optical plate 10.

TABLE 1

| Test samples | Condition |
|---|---|
| 1 | LED |
| 2 | LED + optical plate 10 |
| 3 | LED + optical plate 20 |

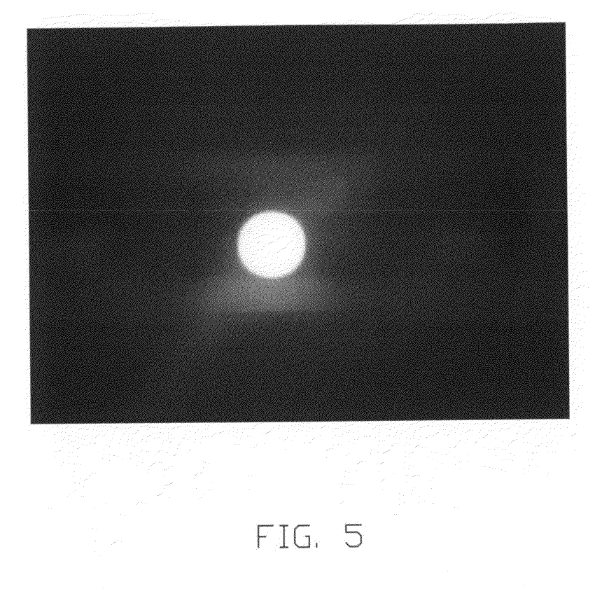

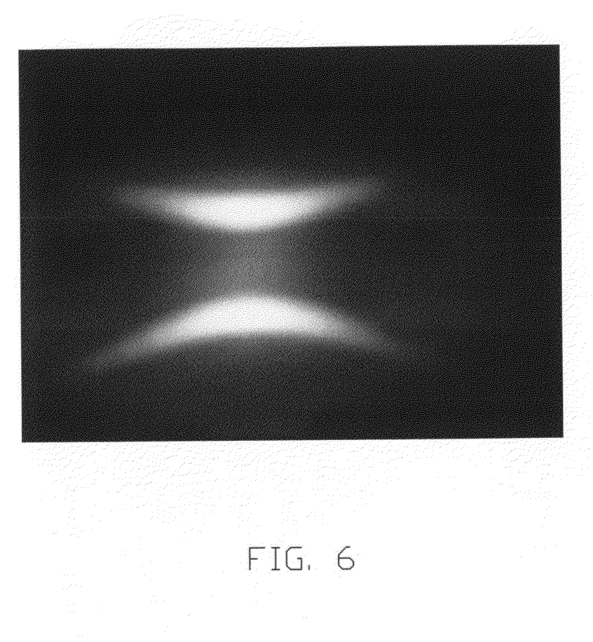

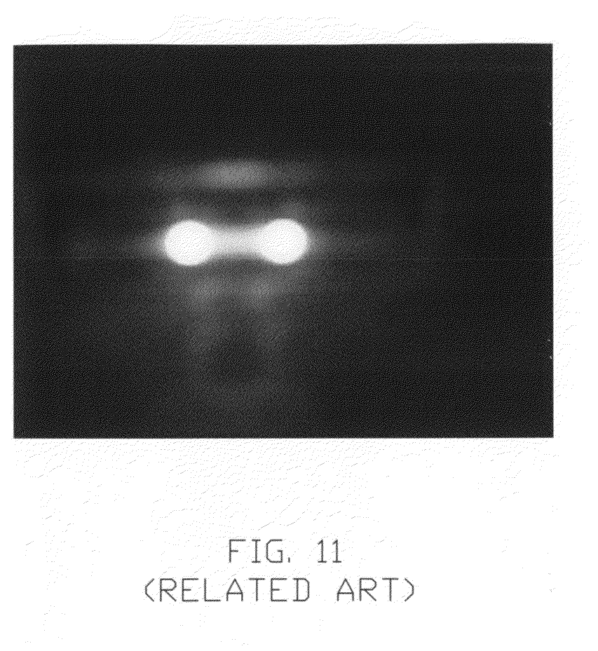

FIGS. 5, 11, and 6 reflect the test results from the test conditions in Table 1. Light emitted from the typical optical plate 10 will form two relatively strong light spots as shown in FIG. 11 and test sample 2. In contrast, light emitted from the optical plate 20 will form two. light strips with higher optical uniformity than light spots as shown in FIG. 6 and test sample 3. The test results show light emitting from the optical plate 20 can translate a spot light, such as light from an LED as shown in FIG. 5 and test sample 1, to a more uniform surface light source.

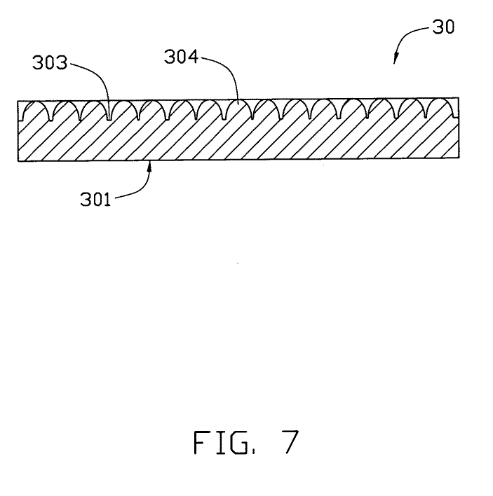

Referring to FIG. 7, a second embodiment of an optical plate 30 is similar in principle to the first embodiment of the optical plate 20, except that a plurality of elongated arc-shaped protrusions 304 formed on a first surface 301 is different from the arc-shaped protrusions 204 of the optical plate 20. A cross-section of each elongated arc-shaped protrusion 304 taken along a plane perpendicular to an extending direction of the elongated arc-shaped protrusions 304 is substantially semi-elliptical.

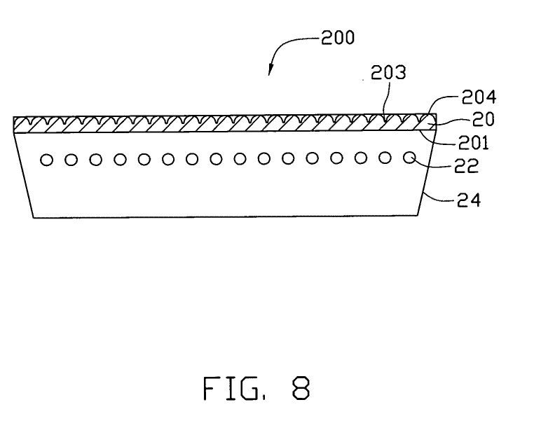

Referring to FIGS. 1 and 8, a backlight module 200 includes a first embodiment of an optical plate 20, a frame 24, and a plurality of linear light sources 22. The linear light sources 22 are positioned in an inner side of the frame 24. In the illustrated embodiment, the linear light sources 22 are cold cathode tubes. The optical plate 20 is positioned on the light sources 22 above a top of the frame 24. The frame 24 may be made of metal materials or plastic materials, and has high reflectivity inner surfaces. In the illustrated embodiment, the first surface 201 is opposite to the linear light sources 22, and the extending direction of each the arc-shaped protrusions 204 on the second surface 203 is substantially parallel to an extending direction of each linear light source 22.

Light emitted from the linear light sources 22 first enters the optical plate 20 via the second surface 203. Since the inner surfaces of the elongated arc-shaped grooves 206 of the second surface 203 are curved, and the elongated arc-shaped protrusions 204 substantially perpendicularly intersect with elongated V-shaped protrusions 205 to form a complex curved surface, incident light that may have been internally reflected on a flat surface, are refracted, reflected, and diffracted. As a result, light outputted from the second surface 203 is more uniform than light outputted from a light output surface of a typical optical plate, and light spots caused by the light sources seldom occur. In addition, an extra upper light diffusion film between the optical plate 20 and the liquid crystal display panel is unnecessary. Thus, the efficiency of light utilization is enhanced.

It may be appreciated that, when a distance between the linear light sources 22 is too long, to improve the optical uniformity of the backlight module 200, a diffusion plate can be employed in the backlight module 200 between the optical plate 20 and the linear light sources 22,. In addition, the linear light sources 22 may be replaced by a plurality of point light sources such as light-emitting diodes, distributed in rows.

It is believed that the present embodiments and their advantages will be understood from the foregoing description, and it will be apparent that various changes may be made thereto without departing from the spirit and scope of the present disclosure or sacrificing all of its material advantages, the examples hereinbefore described merely being preferred or exemplary embodiments of the disclosure.

What is claimed is:

1. An optical plate having a first surface and an opposite second surface, wherein the first surface is substantially planar, and a plurality of substantially parallel elongated V-shaped protrusions and a plurality of substantially parallel elongated arc-shaped protrusions are formed on the second surface of the transparent main body, each elongated arc-shaped protrusion intersects with each elongated V-shaped protrusion.

2. The optical plate as claimed in claim 1, wherein each elongated arc-shaped protrusion substantially perpendicularly intersects with each elongated V-shaped protrusion.

3. The optical plate as claimed in claim 1, wherein a cross-section of each elongated arc-shaped protrusion taken along a plane perpendicular to the extending direction of the elongated arc-shaped protrusions is substantially semicircular or semi-elliptical.

4. The optical plate as claimed in claim 1, wherein a radius of each elongated arc-shaped protrusion is about 0.006 millimeters to about 3 millimeters.

5. The optical plate as claimed in claim 1, wherein a pitch of adjacent elongated arc-shaped protrusions is about 0.025 millimeters to about 1.5 millimeters.

6. The optical plate as claimed in claim 1, wherein a height of each elongated arc-shaped protrusion is about 0.01 millimeters to about 3 millimeters.

7. The optical plate as claimed in claim 1, wherein a top angle of each elongated V-shaped protrusion is about 80 degrees to about 100 degrees.

8. The optical plate as claimed in claim 1, wherein a pitch of adjacent elongated V-shaped protrusions is about 0.025 millimeters to about 1.5 millimeters.

9. The optical plate as claimed in claim 1, wherein a height of each elongated V-shaped protrusion is about 0.01 millimeters to about 3 millimeters.

10. The optical plate as claimed in claim 1, wherein a thickness of the optical plate is about 0.5 millimeters to about 3 millimeters.

11. The optical plate as claimed in claim 1, wherein a material of the optical plate is selected from the group consisting of polycarbonate, polymethyl methacrylate, polystyrene, and copolymer of methylmethacrylate and styrene.

12. A backlight module comprising:
a frame;
a plurality of light sources positioned in an inner side of the frame; and
an optical plate positioned on the light diffusion plate, the optical plate having a first surface and an opposite second surface, wherein the first surface is substantially planar, and a plurality of substantially parallel elongated V-shaped protrusions and a plurality of substantially parallel elongated arc-shaped protrusions are formed on the second surface of the transparent main body, each elongated arc-shaped protrusion intersects with each elongated V-shaped protrusion.

13. The backlight module as claimed in claim 12, further comprising a light diffusion plate positioned on the frame between the light sources and the optical plate.

14. The backlight module as claimed in claim 12, wherein each elongated arc-shaped protrusion substantially perpendicularly intersects with each elongated V-shaped protrusion.

15. The backlight module as claimed in claim 12, wherein the light sources are linear light sources.

16. The backlight module as claimed in claim 12, wherein the first surface is opposite the light sources.

17. The backlight module as claimed in claim 12, wherein an extending direction of the elongated arc-shaped protrusions is substantially parallel to a longitudinal direction of the light sources.

18. The backlight module as claimed in claim 12, wherein a cross-section of each elongated arc-shaped protrusion taken along a plane perpendicular to the extending direction of the elongated arc-shaped protrusions is substantially semicircular or semi-elliptical.
